(19) United States
(12) Patent Application Publication
(10) Pub. No.: US 2006/0203888 A1
(43) Pub. Date: Sep. 14, 2006

(54) Interface randomization methods and systems employing the same

(76) Inventor: George S. Moore, Veradale, WA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/077,071

(22) Filed: Mar. 10, 2005

(51) Int. Cl. H04B 1/69

(52) U.S. Cl. 375/130

(57) ABSTRACT

Some representative embodiments are directed to systems and methods for randomizing data communicated across a digital interface. In some representative embodiments, a PN sequence is applied to a series of shift registers. An array of exclusive-or gates is provided to scramble each bit of the current data word using a respective output of one or several of the shift registers. In some embodiments, a second pseudo-noise sequence is additionally applied in parallel to another array of exclusive-or gates. Additional lines are provided to communicate the PN sequences from the transmitting side to the receiver side. Also, corresponding arrays of exclusive-or gates and shift-registers coupled to the PN sequence lines are disposed on the receiver side to recover the original data using the PN sequences.

### TECHNICAL FIELD

The present application is generally related to communicating digital data across an interface.

### BACKGROUND

In multi-bit digital interfaces, it is often advantageous to randomize data patterns communicated across the interfaces. The randomization may be used to eliminate DC content for AC coupled devices or to scramble any data-dependent interference that may be coupled to analog nodes in the system. Digital interfaces associated with analog-to-digital converters (ADCs) and digital-to-analog converters (DACs) are examples of devices that benefit from such randomization. Specifically, in DACs, there is typically a need to eliminate or reduce the effects of input data patterns coupling onto the analog output. Similarly, digital outputs can couple back into the inputs of ADCs.

Known technologies generate a pseudo-noise (PN) sequence to randomize the data stream. Specifically, for each clock tick, a new bit of the PN sequence is generated. Each bit of the current data word being communicated is exclusive-ored with the current bit of the PN sequence. This method also adds an additional data line to communicate the PN sequence to the receiver side of the interface for the recovery of original data. While this method reduces the data-dependent interface, there are still data-dependent couplings that may occur. For example, if the data word is all Os or all Is, the pattern on every signal line is the PN sequence or its complement respectively.

Another method involves generating a respective PN sequence for each data line. Upon each clock cycle, the respective data bit on each data line is exclusive-ored with the current bit of the data line's PN sequence. Because a different PN sequence is used for each data line, the scrambled signals are uncorrelated with each other and the coupling is more noise-like. However, to enable the original data to be recovered, additional lines are provided to communicate all of the PN sequences to the receiver side. Accordingly, the number of lines required by this method are doubled.

### SUMMARY

Some representative embodiments are directed to systems and methods for randomizing data communicated across a digital interface. In some representative embodiments, a PN sequence is applied to a series of shift registers. An array of exclusive-or gates is provided to scramble each bit of the current data word using a respective output of one or several of the shift registers. In some embodiments, a second pseudo-noise sequence is additionally applied in parallel to another array of exclusive-or gates. Additional lines are provided to communicate the PN sequences from the transmitting side to the receiver side. Also, corresponding arrays of exclusive-or gates coupled to the PN sequence lines are disposed on the receiver side to recover the original data using the PN sequences. By scrambling the communicated data in this manner, the scrambled data streams may be approximated as random and independent of the signal data. Additionally, an asymptotic improvement factor of 4 is achieved for the worst case power coupling for large numbers of data lines as compared to known techniques. Moreover, only one or two additional lines are added to the interface.

### BRIEF DESCRIPTION OF THE DRAWINGS

FIG. 1 depicts a system for communicating digital data according to one representative embodiment.

FIG. 2 depicts another system for communicating digital data according to one representative embodiment.

FIGS. 3 and 4 depict an analog-to-digital converter and a digital-to-analog converter according to some representative embodiments.

### DETAILED DESCRIPTION

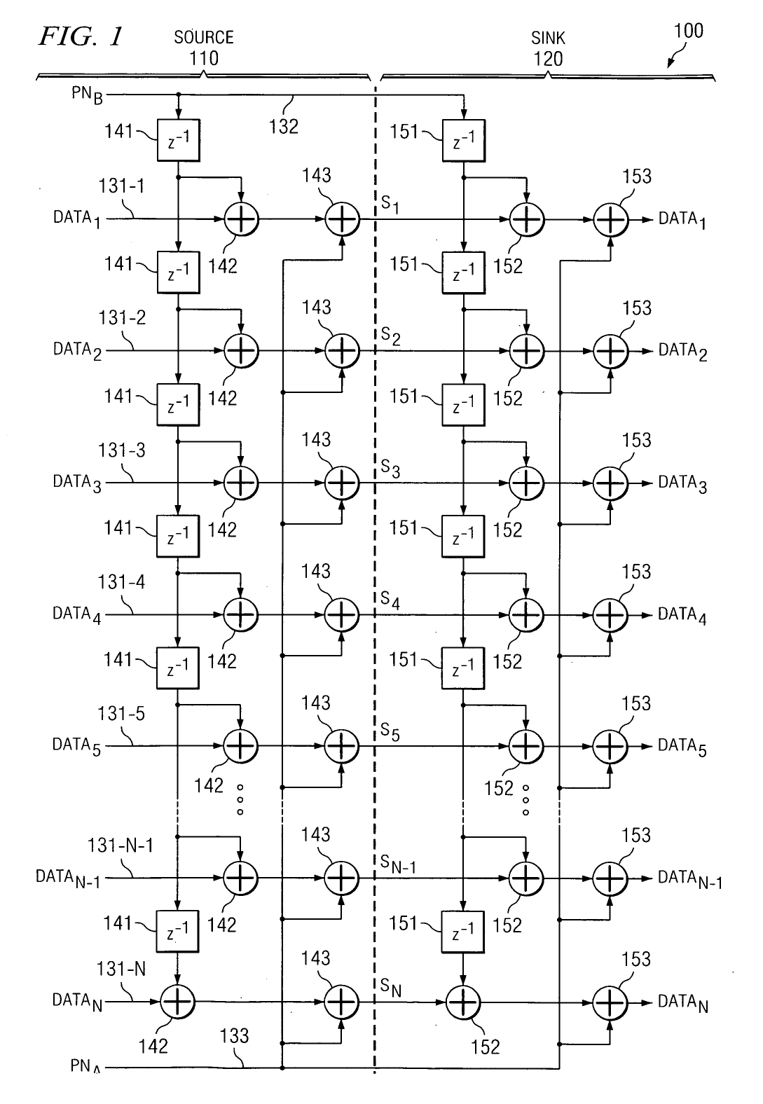

Referring now to the drawings, FIG. 1 depicts system 100 for communicating digital data from source functionality 110 to sink functionality 120 according to one representative embodiment. The dash line in FIG. 1 represents the interface between source functionality 110 and sink functionality 120. Within system 100, there are N lines (131-1 through 131-N) to communicate the respective bits (denoted by Data₁-Data_{N}) of a data word between the source and sink sides of the interface. Additionally, there are two lines 132 and 133 to communicate PN sequences (denoted by PN_{B} and PN_{A} respectively).

Upon each clock cycle, a bit of the PN_{B} sequence is received on line 132. The bits are communicated serially through shift registers 141. A plurality of exclusive-or gates 142 perform an exclusive-or operation on each bit of the data word being communicated with a respective output of one of the shift registers 141. Also, upon each clock cycle, a bit of the PN_{A} sequence is received on line 133. The received bit is applied in parallel to a second set of exclusive-or gates 143 which are also coupled to the respective outputs of the first set of exclusive-or gates 142. System 100 could alternatively be implemented to perform the parallel exclusive-or operations with the PN_{A} sequence before performing the exclusive-or operations with the PN_{B} sequence. The outputs (denoted by S₁ through S_{N}) of exclusive-or gates 143 form the scrambled bits communicated across the interface. Pipelining delays (not shown) could be applied to the scrambled bits as long as the same operations are applied consistently. Additionally, the discussion has assumed that a single line exists for each data signal and for each PN sequence. However, multiple lines may be employed. For example, two lines could be used for each signal and each PN sequence to support differential signaling.

Line 132 used to receive the PN_{B} sequence extends across the interface to sink functionality 120. Another set of shift registers 151 are serially coupled to line 132 on the sink side of the interface. Each scrambled data bit is applied to an exclusive-or gate 152 to be exclusive-ored with an output of one of the shift registers 151. Line 133 used to receive the PN_{A} sequence also extends across the interface to sink functionality 120. A final set of exclusive-or gates 153 exclusive-ors the current bit of the PN_{A} sequence with the respective bits of the outputs of exclusive-or gates 152 to recover the original data.

The relationship of each scrambled data signal is given by:
Sₖ(m)=Dataₖ(m)⊕PN_{A}(m)⊕PN_{B}(m−k) (eq. 1)
where ⊕ signifies the exclusive-or operation. The receiving structure on the sink side of the interface is a duplicate of the source side. Hence, the output signal is given by:
Dataₖ(m)=Dataₖ(m)⊕ PN_{A}(m)⊕PN_{B}(m−k)⊕PN_{A}(m)⊕PN_{B}(m−k) (eq. 2)

Rearranging equation (2), the following is obtained:
Dataₖ(m)=Dataₖ(m)⊕[PN_{A}(m)⊕PN_{A}(m)]⊕[PN_{B}(m−k)⊕PN_{B}(m−k)] (eq. 3)

Since PN_{A}(m)⊕(PN_{A}(m)=0 and PN_{B}(m−k)⊕PN_{B}(m-k)=0, it is seen that the original data is recovered.

The scrambled data communicated across the interface can also be described and implemented as follows:
Sₖ(m)=Dataₖ(m)⊕[PN_{A}(m)⊕PN_{B}(m−k)] (eq. 4)

This representation emphasizes that each data bit is exclusive-ored with a scrambling signal that is the exclusive-or of PN_{A} and a delayed version of PN_{B}. Each scrambling sequence employs a different delay value for PN_{B}.

By suitably selecting the PN_{A} and PN_{B} sequences, the scrambled data signals (S₁ through S_{N}) can be relatively independent irrespective of the communicated data. A number of choices for the PN_{A} and PN_{B} sequences can be made to achieve the desired independence. In one embodiment, the PN_{A} and PN_{B} sequences are obtained from respective constituent maximal length shift register sequence (MLSRS) generators of a Gold code generator. With this selection, each scrambling sequence is a different Gold code from the set associated with the generator pair. These codes are known to possess excellent cross-correlation characteristics. In another embodiment, two MLSRS generators of relatively prime lengths (Q and R) may be employed. The resulting sequences are all of the same QR length sequence while being separated in a delay by at least the lesser of Q and R. Other selections may be made depending upon the desired amount of independence for particular applications.

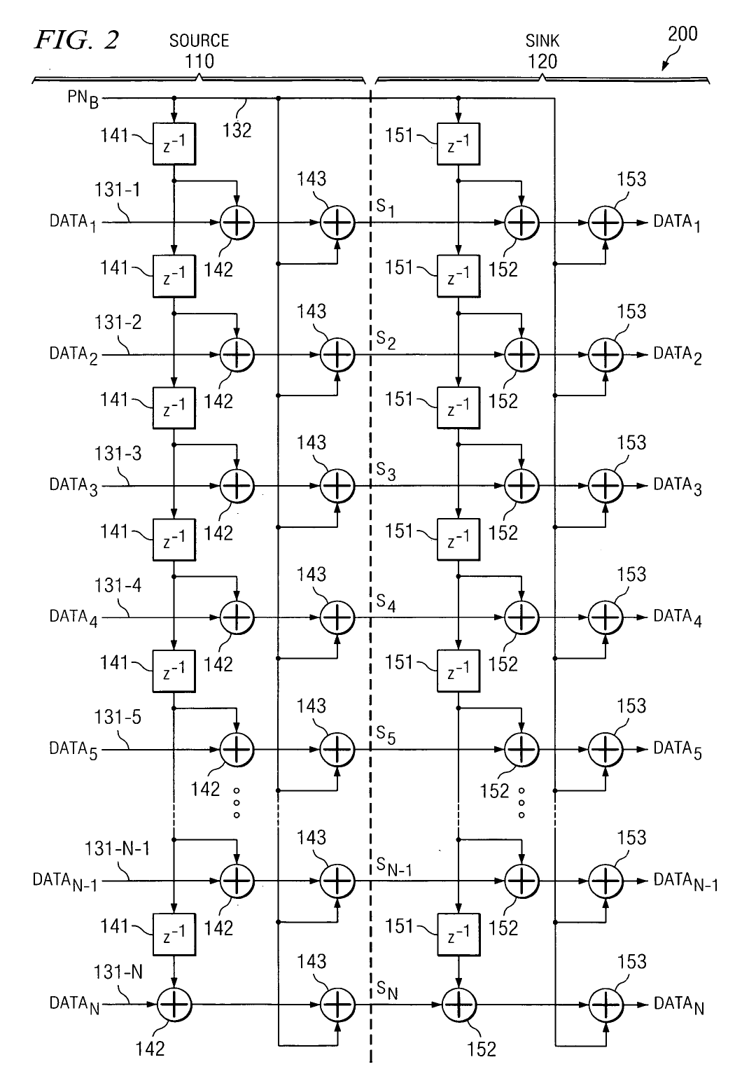

FIG. 2 depicts system 200 for communicating digital data according to another representative embodiment. System 200 operates in a manner that is substantially similar to the operation of system 100 except that only one PN sequence (the PN_{B} sequence) is applied to both the serial arrangements of shift registers and the parallel arrangements of exclusive-or gates. Specifically, a single line (line 132) receives the PN_{B} sequence. Line 132 is coupled serially to shift registers 141 and is coupled in parallel to exclusive-or gates 143 on the source side of the interface. Likewise, line 132 is serially coupled to shift registers 151 and coupled in parallel to exclusive-or gates 153 on the sink side of the interface.

If the PN_{B} sequence is obtained from a MLSRS generator, the known shift-and-add property of these generators will result in the scrambling sequences being the same sequences at deterministic offsets from one another. For a particular generator, these offsets may be assessed to determine if they are sufficiently separated from one another such that the scrambling sequences may be considered sufficiently independent. Additionally, although a single unit of delay is shown in FIGS. 1 and 2, multiple units of delay may be employed between the shift registers as long as the same pattern of delay is used on the source and sink sides of the interface. Similarly, exclusive-or gates 142 and 152 may perform their exclusive-or operations using the outputs of multiple shift-registers 141 and 151 as long as the same operations are performed on both sides of the interface. With these additional degrees of freedom, the scrambling sequences can be tailored to ensure sufficient independence. Specifically, by obtaining suitable offsets for each data line, the scrambling applied to each data line appears to be independent over the “short term” even though delayed versions of the same sequence are actually being applied to all of the data lines.

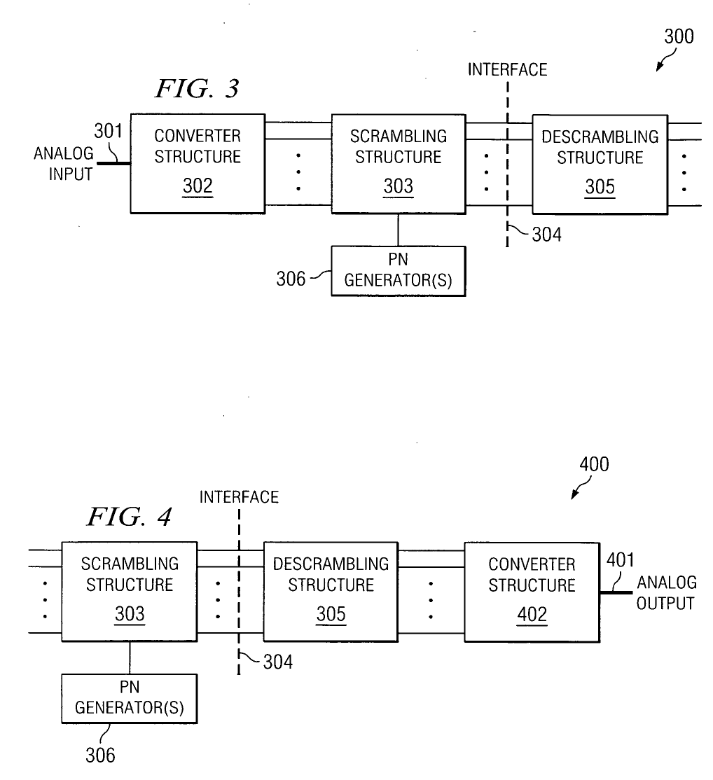

The communication of digital data according to some representative embodiments may occur in any suitable digital device. For example, FIG. 3 depicts analog-to-digital converter (ADC) 300 according to one representative embodiment. ADC 300 comprises line 301 to receive an analog input signal. ADC 300 comprises typical converter structure 302 that generates digital words related to the levels of the analog input signal. The digital words are scrambled by scrambling structure 303 using PN generator(s) 306. The scrambled data words are communicated across interface 304. Descrambling structure 305 descrambles the data for further processing. By arranging ADC 300 in this manner, line 301 experiences a lower amount of power coupling and the coupling that does occur is more noise-like. Additionally, the scrambling functionality does not unduly increase the number of digital lines in the device and does not involve undue circuit complexity. Similarly, FIG. 4 depicts digital-to-analog converter (DAC) 400 according to one representative embodiment. DAC 400 operates in substantially the same manner as ADC 300. However, analog output line 401 and converter structure 402 that converts the digital data into an analog signal are disposed after descrambling structure 305.

What is claimed is:

1. A system comprising:
a first plurality of shift registers coupled in series to receive a first pseudo-noise (PN) sequence;
a first array of exclusive-or gates for performing a respective exclusive-or operation on each bit of a data word to be communicated across an interface using said first plurality of shift registers;
a second array of exclusive-or gates, coupled in parallel to receive a second PN sequence, for performing a respective exclusive-or operation on each bit of said data word;
a second plurality of shift registers coupled in series to receive said first PN sequence;
a third array of exclusive-or gates for performing a respective exclusive-or operation on each bit of a data word communicated across an interface using said second plurality of shift registers; and
a fourth array of exclusive-or gates, coupled in parallel to receive said second PN sequence, for performing a respective exclusive-or operation on each bit of said communicated data word.

2. The system of claim 1 wherein the first and second PN sequences are the same PN sequence.

3. The system of claim 1 further comprising:
first and second maximal length shift register sequence (MLSRS) generators of a Gold code generator, wherein said first PN sequence is received from said first MLSRS generator and said second PN sequence is received from said second MLSRS generator.

4. The system of claim 1 further comprising:
first and second maximal length shift register sequence (MLSRS) generators of relatively prime lengths for generating said first and second PN sequences.

5. The system of claim 1 wherein at least one shift register of both of said first and second plurality of shift registers operates according to multiple units of delay.

6. The system of claim 1 wherein at least one gate of both of said first and third arrays of exclusive-or gates performs an exclusive-or operation using outputs from multiple shift-registers.

7. The system of claim 1 wherein said system is selected from the group consisting of: an analog-to-digital converter and a digital-to-analog converter.

8. The system of claim 1 further comprising:
an analog node that experiences coupling to lines that communicate scrambled bits from said transmitting side of said system to said receiving side of said system.

9. A method, comprising:
applying a first pseudo-noise (PN) sequence to a first plurality and a second plurality of serially coupled shift registers;
performing a first exclusive-or operation on each bit of a digital word using said first plurality of shift registers and a second exclusive-or operation on each bit of said digital word using a current bit of a second PN sequence to generate a scrambled digital word;
communicating bits of said scrambled digital word across an interface in parallel; and
performing a third exclusive-or operation on each bit of said scrambled digital word using said second plurality of shift registers and a fourth exclusive-or operation on each bit of said scrambled digital word using said current bit of said second PN sequence to recover said digital word.

10. The method of claim 9 wherein said first and second PN sequences are the same PN sequence.

11. The method of claim 9, further comprising:
generating said first PN sequence using a first maximal length shift register sequence (MLSRS) generator of a Gold code generator; and
generating said second PN sequence using a second MLSRS generator of said Gold code generator.

12. The method of claim 9, further comprising:
generating said first and second PN sequences using respective maximal length shift register sequence (MLSRS) generators that possess relatively prime lengths.

13. The method of claim 9 wherein at least one shift register of both of said first and second plurality of shift registers operates according to multiple units of delay.

14. The method of claim 9 wherein at least one bit of said data word is exclusive-ored with multiple outputs of said first plurality of shift registers and at least one bit of said scrambled data word is exclusive-ored with multiple outputs of said second plurality of shift registers.

15. The method of claim 9 further comprising:
performing analog-to-digital conversion to generate said digital word.

16. The method of claim 9 further comprising:
performing digital-to-analog conversion after recovering said digital word.

17. A system, comprising:
first means for serially registering a first pseudo-noise (PN) sequence;
means for scrambling each bit of a data word using said first means for serially registering and a current bit of a second PN sequence;
means for communicating said scrambled digital word in parallel across an interface;
second means for serially registering said first PN sequence; and
means for unscrambling each bit of said scrambled data word using said second means for serially registering and said current bit of said second PN sequence.

18. The system of claim 17 wherein said first and second PN sequences are the same PN sequence.

19. The system of claim 17 further comprising:
first and second maximal length shift register sequence (MLSRS) generators of a Gold code generator, wherein said first PN sequence is received from said first MLSRS generator and said second PN sequence is received from said second MLSRS generator.

20. The system of claim 17 further comprising:
first and second maximal length shift register sequence (MLSRS) generators of relatively prime lengths for generating said first and second PN sequences.
